(19) United States
(12) Patent Application Publication
(10) Pub. No.: US 2008/0164210 A1
(43) Pub. Date: Jul. 10, 2008

(54) FRACTION COLLECTION AND IDENTIFICATION SYSTEM

(75) Inventor: Nicholas DeMarco, Burlington, WI (US)

Correspondence Address: Varian Inc.;Legal Department, 3120 Hansen Way D-102, Palo Alto, CA, 94304, US

(73) Assignee: ANALOGIX, INC., Burlington, WI (US)

(21) Appl. No.: 11/696,609

(22) Filed: Apr. 4, 2007

Related U.S. Application Data
(60) Provisional application No. 60/883,693, filed on Jan. 5, 2007.

(51) Int. Cl. G01N 30/82

(52) U.S. Cl. 210/656; 210/198.2

(57) ABSTRACT

An apparatus to perform a chromatography process includes a fraction collection system with a rack adapted to support at least one receptacle and a reader coupled to the fraction collection system. The reader is operable to detect a first identification coupled to the rack. The apparatus also includes a chromatography system connected to the fraction collection system to supply a fraction to the receptacle, and a RFID system. The RFID system communicates with the reader and generates data identifying a first location of the receptacle with respect to the rack and a second location of the rack with respect to the fraction collection system.

### RELATED APPLICATIONS

This patent application claims the benefit of U.S. Provisional Patent Application No. 60/883,693 filed on Jan. 5, 2007.

### BACKGROUND

Chromatography is one example of an analytical chemistry procedure that can employ a fraction collection system. Chromatography is used to analyze the constituents, or fractions, of a sample of interest, and, in some cases, to collect each of the fractions of the sample of interest separately for further analysis or use. Chromatography generally relates to any of a variety of techniques used to separate complex mixtures based on the differential affinities of the fractions of the sample for a mobile phase with which the sample flows, and a stationary phase through which the sample passes.

Generally, liquid chromatography includes a stationary phase that includes a finely powdered solid adsorbent packed into a chromatography cartridge or column, and the mobile phase includes one or more eluting solvents that are moved through the cartridge by a pump. The sample to be analyzed by liquid chromatography is injected into the cartridge and monitored by a detector. The detector provides identification and/or differentiation of the fractions as the fractions elute from the cartridge. One type of liquid chromatography, flash chromatography, includes a cartridge (in some cases, a disposable cartridge) filled with the stationary phase (e.g., silica gel), and the sample to be separated is placed on top of the stationary phase. The cartridge is filled with an isocratic or gradient solvent which, with the help of pressure, enables the sample to run through the cartridge and become separated. Liquid chromatography, and particularly, flash chromatography can be used for a variety of applications, including, but not limited to, drug discovery, sample clean-up, and natural product purification, among others.

### SUMMARY

In one embodiment, the invention provides an apparatus to perform a chromatography process. The apparatus includes a fraction collection system with a rack adapted to support at least one receptacle, and a reader coupled to the fraction collection system. The reader is operable to detect a first identification coupled to the rack. The apparatus also includes a chromatography system connected to the fraction collection system to supply a fraction to the receptacle, and a RFID system. The RFID system communicates with the reader and generates data identifying a first location of the receptacle with respect to the rack and a second location of the rack with respect to the fraction collection system.

In another embodiment, the invention provides a method of conducting a chromatography process. The method includes staring a chromatography process by providing a fraction to the at least one receptacle, mounting a rack to a fraction collection system, and detecting a label with a reader as a result of mounting the rack. The method also includes transmitting a signal to a RFID system, the signal related to the label coupled to the rack as a result of detecting the label, and generating a set of data with the RFID system. The set of data includes at least one characteristic of the chromatography process, the position of the at least one receptacle with respect to the rack, and the position of the rack with respect to the fraction collection system.

### BRIEF DESCRIPTION OF THE DRAWINGS

FIG. 1 is a schematic of a chromatography apparatus according to one embodiment of the present invention.

FIG. 2 is a perspective view of a fraction collector of the chromatography apparatus illustrated in FIG. 1.

FIG. 3 is a partial perspective view of a frame of the chromatography apparatus illustrated in FIG. 1.

FIG. 4 is a flow chart of a method for performing a chromatography process utilizing the chromatography apparatus of FIG. 1.

FIG. 5 is a perspective view of another fraction collector of the chromatography apparatus illustrated in FIG. 1

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “supported,” and “coupled” and variations thereof are used broadly and encompass both direct and indirect mountings, connections, supports, and couplings. Further, “connected” and “coupled” are not restricted to physical or mechanical connections or couplings, but can include, for example, electrical and fluid connections or couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

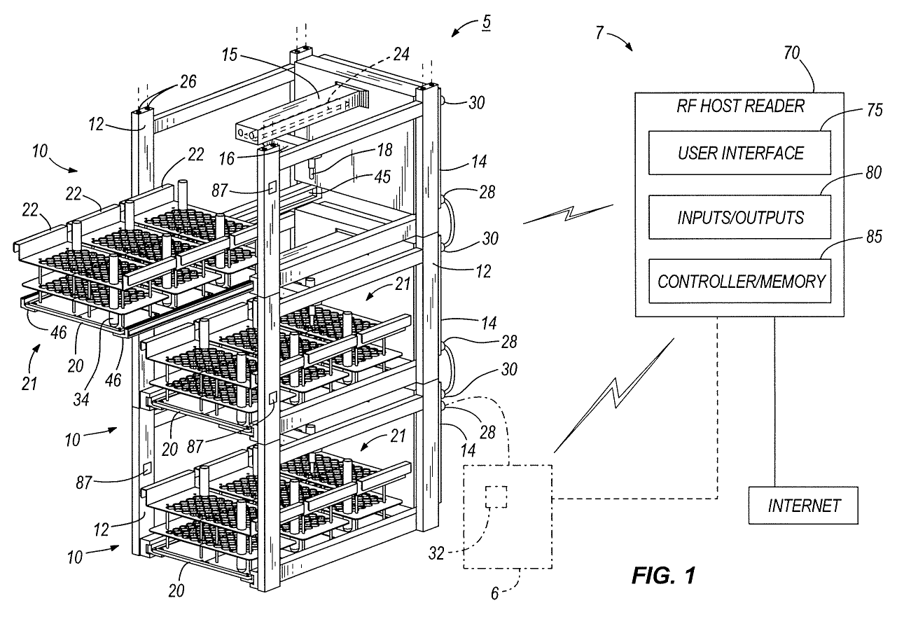

FIG. 1 illustrates a schematic of a chromatography apparatus according to one embodiment of the present invention. The chromatography apparatus includes a fraction collection system 5, a chromatography system 6, and a radio frequency identification (RFID) system 7. The fraction collection system 5 is in communication with the chromatography system 6 and the RFID system 7 to perform a chromatography process. In other constructions, however, the present invention can include the fraction collection system 5 in communication with a system other than the chromatography system 6 to process chemicals or fluids. In other words, it is envisioned that the fraction collection system 5 and the RFID system 7 can be utilized in other applications including chemical processes or fluid distribution processes to facilitate and/or improve such processes.

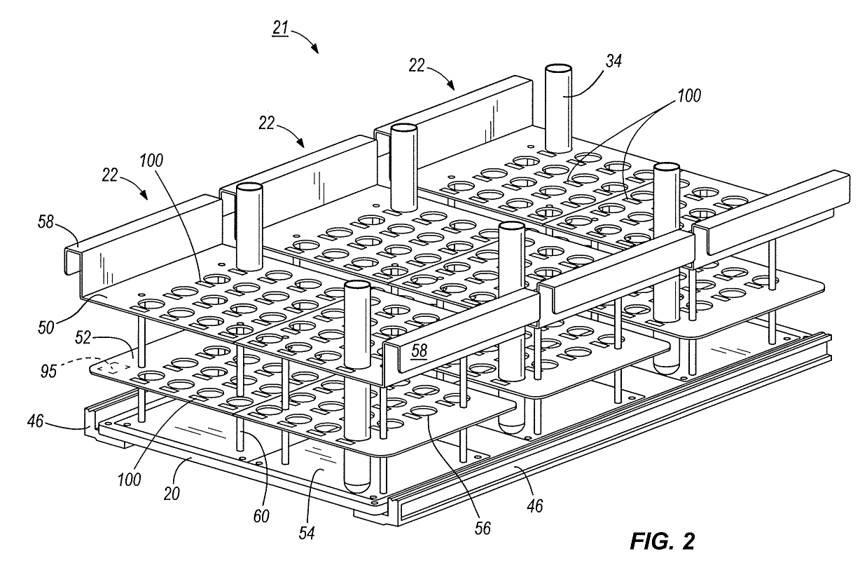

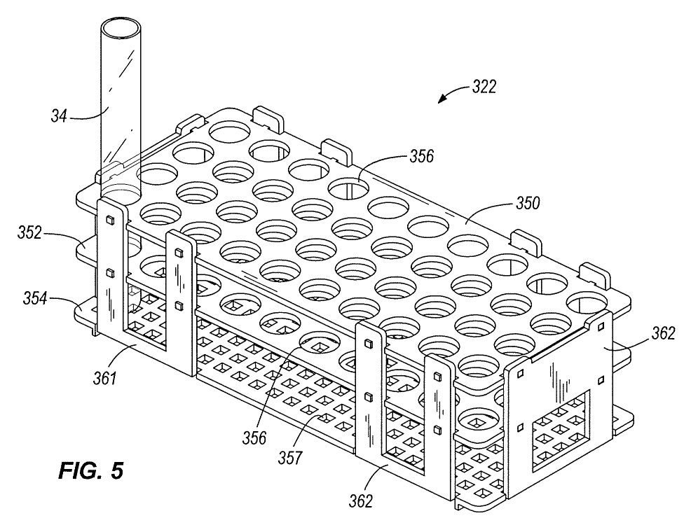

The fraction collection system 5 includes three stackable fraction collectors 10. It should be understood that the actual number of fraction collectors 10 in any given fraction collection system 5 can vary (i.e., can be more or less than three). Each fraction collector 10 includes a frame 12, a controller 14, a first arm 15 having a track 24 defined therein, a second arm 16 movable with respect to the first arm 15 via the track 24, a nozzle 18 coupled to the second arm 16, and an adapter tray 20 that supports a collection rack assembly 21. Each collection rack assembly 21 can include one or more collection racks 22, 322 (as shown in FIGS. 2 and 5, respectively) for supporting receptacles 34. The collection rack 322 can be used with the fraction collection system 5 illustrated in FIG. 1, however, for ease of description only, the collection rack 22 is further described herein with respect to FIG. 1.

The frame 12 supports the first arm 15 and the second arm 16 near the top of the fraction collector 10, and supports the adapter tray 20 near the bottom. The frame 12 can include any of a variety of structures, such as protrusions, recesses, openings, or combinations thereof to allow the fraction collectors 10 to be stacked by inter-engagement of such structures. For example, the top of the frame 12 includes protrusions 26 and the bottom of the frame 12 includes complementary recesses (not shown) to secure the frames 12 with respect to one another when stacked.

Each fraction collector 10 includes a controller 14. The controller 14, whether dedicated or universal, provides instructions to control the motion of the second arm 16 of each fraction collector 10. Each controller 14 includes an input connection 28 and an output connection 30. The input connection 28 allows the controller 14 to receive instructions based on a chromatography analysis being performed, for example. These instructions may come from a variety of suitable sources of instruction. One suitable source includes, but it is not limited to, a controller or microprocessor unit 32, which may be a part of, or used in conjunction with, the chromatography system 6. The output connection 30 allows fraction collectors 10 to be connected in a series configuration by passing instructions to the input connection 28 on another fraction collector 10. In some embodiments, the fraction collectors 10 of the fraction collection system 5 are connected in parallel. Some embodiments can include a combination of fraction collectors 10 connected in series and fraction collectors 10 connected in parallel.

With further reference to FIG. 1, a first end of the first arm 15 is coupled to an upper portion of the frame 12, and a second end of the first arm 15 is cantilevered over the collection rack assembly 21. The nozzle 18 is coupled to a first end of the second arm 16. The nozzle 18 is directed downwardly and is adapted to dispense collected fractions into receptacles 34. A second end of the second arm 16, opposite the first end, is coupled to the first arm 15, and particularly, to the track 24 defined by the first arm 15. To access all of the receptacles 34 in a collection rack 22, the second arm 16 is rotationally and translationally movable relative to the first arm 15 in a polar coordinate system. To accomplish this, the length of the track 24 can be greater than the length of the second arm 16. The controller 14 can receive r and 0 coordinates (e.g., from the controller 32) corresponding to the location of a destination receptacle 34 for a given fraction, and the controller 14 can activate the second arm 16 (e.g., via activation of a motor) to move relative to the first arm 15 accordingly.

In other constructions of the fraction collection system 5, the second arm 16 can be moved in a linear direction along the track 24, and can also pivot about a connection point between the first arm 15 and the second arm 16. As a result, the nozzle 18 can be positioned above any desired receptacle 34 by a combination of translational and/or rotational motions. A variety of coordinate systems can be employed to control the movement of the nozzle 18 relative to the receptacles 34. For example, other embodiments of the present invention may include a two or three dimensional Cartesian coordinate system for positioning the nozzle 18 over a desired receptacle 34 for expulsion of one or more fractions.

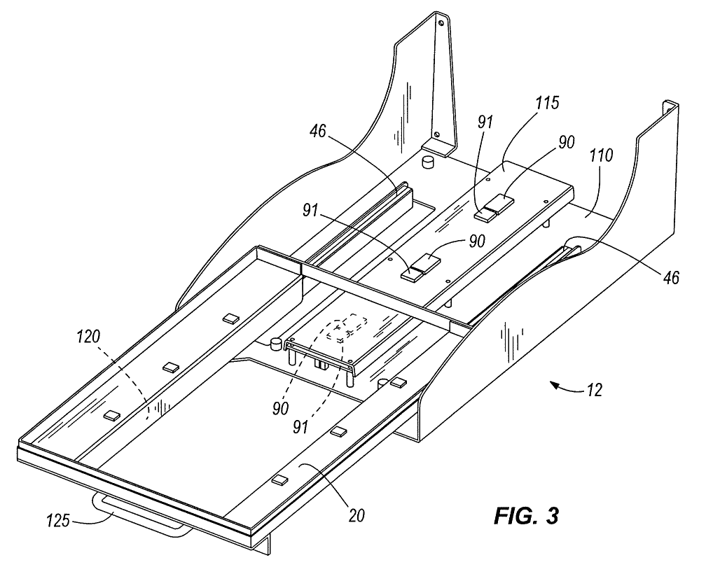

With reference to FIGS. 2 and 3, the fraction collector 10 further includes a slide mechanism or one or more tracks 46 coupled to two opposing sides of the adapter tray 20 to allow the adapter tray 20 to slide in and out of the frame 12 below the first and second arms 15, 16, and the nozzle 18. As shown in FIG. 2, each collection rack 22 includes an upper divider 50, a lower divider 52, and a base plate 54. The base plate 54 supports the receptacles 34, and is shaped and dimensioned to fit within one corresponding recess (not shown) on the adapter tray 20 to inhibit the collection racks 22 from moving or shifting with respect to the adapter tray 20.

The upper and lower dividers 50, 52 have a number of apertures 56 each configured to receive a receptacle 34, such as a test tube. In some constructions, the apertures 56 included on the upper and lower dividers 50, 52 can be uniformly sized, as shown in FIG. 2, for example. However, other constructions can include the upper and lower dividers 50, 52 having some apertures 56 of one size and shape, and other apertures of another size and shape based on the application of the fraction collection system 5. Similarly, the spacing between the apertures 56 may vary from the generally uniform spacing between the apertures 56 as shown in FIG. 2.

With further reference to FIG. 2, the upper divider 50 can include a handle 58 to allow a user to grasp the collection rack 22 during placement or removal of the collection rack 22 from the adapter tray 20. The upper divider 50, lower divider 52, and base plate 54 are coupled together and maintained at a distance from each other via standoffs 60. The standoffs 60 are sufficiently rigid to resist shifting or rotating of the upper and lower dividers 50, 52 with respect to one another to maintain the receptacles 34 in a substantially vertical orientation when positioned in the aperture 56.

FIG. 5 illustrates another collection rack 322 according to another embodiment of the present invention. The collection rack 322 includes an upper divider 350, a lower divider 352, and a base plate 354. The upper and lower dividers 350, 352 include a number of apertures 356 to receive receptacles 34 (only one shown in FIG. 5). The apertures 356 shown in FIG. 5 are uniformly sized and distributed. However, other constructions of the collection rack 322 can include the upper and lower dividers 350, 352 having some apertures 56 of one size and shape, and other apertures of another size and shape based on the application of the fraction collection system 5. The base plate 354 supports receptacles 34 and includes other apertures 357. The base plate 354 is shaped and dimensioned to operate with the adapter tray 20 to inhibit the collection rack 322 from moving or shifting with respect to the adapter tray 20. The upper divider 350, lower divider 352, and base plate 354 are coupled together with four generally U-shaped connector plates 361 coupled to the broad side of the dividers and plates 350, 352, 354, and two generally square connector plates 362, each connected to one narrow side of the dividers 350, 352 and plate 354. It is to be understood that other constructions of the trays 22, 322 can include other configurations that fall within the scope of the invention.

With reference to FIGS. 2 and 5, the collection racks 22, 322 are manufactured of non-conductive materials, such as plastic. Alternatively, at least some portions of the fraction collector 10 also can be manufactured of non-conductive materials.

Each collection rack 22, 322 also includes a rack label 95 (only one shown in FIG. 2) and a number of aperture labels 100. In the particular construction shown in FIG. 2, the rack label 95 is positioned on the lower surface of the lower divider 52. However, the location of the rack label 95 can vary based on the application of the fraction collection system 5. For example, some constructions can include the rack label 95 being mounted on the handle 58.

Each aperture label 100 is positioned adjacent to one corresponding aperture 56 for identification of the particular aperture 56 and/or receptacle 34 supported by the aperture 56. Based on the application or use of the fraction collection system 5, the labels 95 and 100 can each selectively include a radio frequency identification tag (“RFID tag”), an engraved plaque, a machine readable label, or other suitable label for identification purposes. In cases when the rack label 95 is a RFID tag (or other wireless communication device), the rack label 95 can be programmable and include a memory to store instructions and relevant information related to a chromatography process, for example. The term “label” also encompasses an identification-type mark molded into the rack during an injection molding process, thus making labels 95 and 100 an integral part of the rack, for example.

FIG. 3 illustrates a portion of an alternative construction of the frame 12. More specifically, FIG. 3 illustrates the lower portion of the alternative frame 12 including a bottom plate 110 and a support plate 1 5. The support plate 1 5 includes a surface substantially parallel to the bottom plate 110 and is raised from the bottom plate 10. The bottom plate 110 can hold chromatography media or fluid that may spill from a collection rack 22, 322 placed above the bottom plate 110, for example. In this particular construction, the adapter tray 20 includes a pair of lower edges 120 (only one shown in FIG. 3) each received by a corresponding track 46, and a handle 125 for manipulating the adapter tray 20. It is to be understood that other constructions of the frame 12 fall within the scope of the invention.

FIG. 3 also shows three rack readers 90 mounted fixedly on the surface of the support plate 1 5. A rack reader 90 can include a rack reader IC chip with communication and buffer circuitry, among other elements. Additionally, the rack reader 90 can be connected to a power source, an antenna, and other elements not described herein. In one construction, the rack reader 90 is a CRX14 Contactless Coupler Chip provided by STMicroelectronics. Each of the rack readers 90 shown in FIG. 3 is designed to “read” or detect at least one rack label 95 mounted on the collection rack 22, 322. For example, in one construction, the rack label 95 is a SRI4K Short Range Contactless Memory Chip provided by STMicroelectronics. In the construction illustrated in FIG. 3, each rack reader 90 is coupled to an antenna 91 to communicate with the RFID system 7. In other constructions, the three rack readers 90 can communicate with the RFID system 7 through a common communication interface, such as an I2C interface (not shown). In yet other constructions, other communication devices (e.g., transceiver) can be coupled or integrated to the rack readers 90 to communicate with the RFID system 7.

In the particular construction illustrated in FIGS. 2 and 3, the rack label 95 is positioned on a surface of the collection rack 22 such that when the collection rack 22 is positioned at a desired location with respect to the frame 12, the rack reader 90 under the adapter tray 20 can detect the presence of the collection rack 22. It is to be understood that the number of rack readers 90 coupled to the frame 12 may depend on the number of collection racks 22 supported by the adapter tray 20. For example, FIG. 2 shows each adapter tray 20 supporting three collection racks 22. Accordingly, FIG. 3 shows three rack readers 90 mounted under the adapter tray 20 to detect the three collection racks 22. Other constructions can include a single rack reader 90 detecting more than one rack label 95. As already discussed, the collection rack 322 shown in FIG. 5 may also include a rack label 95 to be read by a corresponding rack reader 95 shown in FIG. 3.

With reference to FIG. 1, the RFID system 7 includes a RF host reader 70 having a user interface 75, one or more input/output connectors 80, and a controller 85 with a memory. The user interface 75 can be used to manually enter information related to a tag 87 generally identifying each fraction collector 10. The tag 87 can be coupled to the frame 12 at various locations of the fraction collector 10. Similar to the labels 95 and 100, each tag 87 can include RF readable tags, machine readable codes, engraved plaques, and other identification devices suitable with the application of the fraction collection system 5. In this particular construction, the RF host reader 70 communicates wirelessly (e.g., RF, laser, IR) with the rack readers 90 mounted on the support plate 115 (shown in FIG. 3). In addition, each of the rack readers 90 can communicate with a corresponding rack label 95 to upload and save information in the memory of the rack label 95. The RF host reader 70 can also communicate with the chromatography system 6 wirelessly or via a cable connection. The RF host reader 70 is also connected to an intranet or the internet via a local area network (LAN) or other suitable communication network to send and receive information regarding the fraction collection system 5 and the chromatography system 6.

Alternative constructions of the fraction collection system 5 can include a reader (not shown) having a transceiver or other communication means mounted on the second arm 16 or nozzle 18 of the fraction collector 10. Accordingly, the second arm 16 is operable to move the reader to a desired proximity to the rack labels 95 and/or aperture labels 100. For example, in cases when the second arm 16 and/or the nozzle 18 are operated based on a three dimensional Cartesian coordinate system, the reader can also be positioned at a desired three dimensional coordinate to read labels 95, 100, tags 87, and other suitable labels mounted to the fraction collection system 5 regardless of position and orientation of the labels 95, 100, tags 87 with respect to the frame 12.

During operation of the fraction collection system 5, the chromatography system 6, and the RFID system 7 shown in FIG. 1, the nozzle 18 can be fluidly coupled to a detector of the chromatography system 6. The fractions of a sample of interest can be separated by passage through one or more chromatography cartridges, identified by a detector, and sent to the fraction collection system 5 to be collected. Fractions can be sent to any nozzle 18 of the fraction collection system 5, or to waste, as instructed by a user or peak detection software (also sometimes referred to as fraction collection software). When a fraction is sent to a nozzle 18, the controller 14 operates the second arm 16 to move the nozzle 18 to a position above a desired receptacle 34. In some constructions, at least one of the rack readers 90 is connected to a sensor (not shown) to help the RF host reader 70 identify characteristics of the fraction sent through the nozzle 18. Other constructions include the chromatography system 6 uploading such characteristics directly to the RFID system 7. For example, the information provided to the RF host reader 70 can include flow rates, time of fraction flow, and the type of fraction dispensed by the nozzle 18.

Based on the communication between the rack readers 90 and/or the chromatography system 6 with the REID system 7, the RF host reader 70 can generate information related to a chromatography process in a particular collection rack 22, 322, for example. The RF host reader 70 can generate information related to each collection rack 22, 322 identifying the apertures 56 that support a receptacle 34, which receptacle(s) 34 are filled or partially filled with a fraction, and the fraction characteristics related to each receptacle 34 in a particular collection rack 22, 322. This information can also be uploaded by the rack reader 90 to the rack labels 95 coupled to the collection racks 22, 322. In some cases, for the RF host reader 70 to generate information related to the rack labels 95 and aperture labels 100, data is entered into the RFID system 7 manually through the user interface 75. In other constructions, the RF host reader 70 can generate information related to the collection rack 22, 322 without having to enter label information manually. For example, rack labels 95 and/or aperture labels 100 can include a touchless or wireless system, which cooperates and interacts with the rack readers 90.

In one application related to the construction shown in FIG. 1, the RF host reader 70 generates information related to a chromatography process performed in the fraction collection system 5. More specifically, the RF host reader 70 can generate information related to the receptacles 34 supported in a collection rack 22, 322 being used in a chromatography process based on information sent by the rack readers 90 and/or information entered manually. The information generated by the rack readers 90, which is specific to each collection rack 22, 322, can also be saved in the corresponding rack label 95. Accordingly, the RFID system 7 can identify and monitor more than one chromatography process based on the information generated by the RF host reader 70. At the same time, the information corresponding to each collection rack 22, 322 is stored in rack label 95 corresponding to such collection rack 22, 322.

The host reader 70 can make available the chromatography information (e.g., fraction type, flow rates, time stamps) to an intranet or to a local area network (LAN) connected to the internet. As a result, a user can access and review the information generated by the RF host reader 70 regarding a chromatography process at a remote computer or device. For example, a stand alone device capable of performing a chromatography process can utilize the information generated by the RF host reader 70 to continue an already started chromatography process. More specifically, a user can remove a collection rack 22, 322 from the fraction collection system 5 and place the rack 22, 322 in the stand alone chromatography device, which can include a display system to show the information stored in the rack label 95 coupled to such collection rack 22, 322. As a result, the user can continue the chromatography process based on the displayed information. In addition, the user can access the information uploaded by the host reader 70 in the internet to confirm and/or complement the information stored in the rack label 95. In addition, the user can remove the collection rack 22, 322 from the fraction collection system 5 at any time, before, during, or after, a chromatography process, and position the rack 22, 322 in a remote chromatography system and/or a chromatography system different than the one being used or intended to be used.

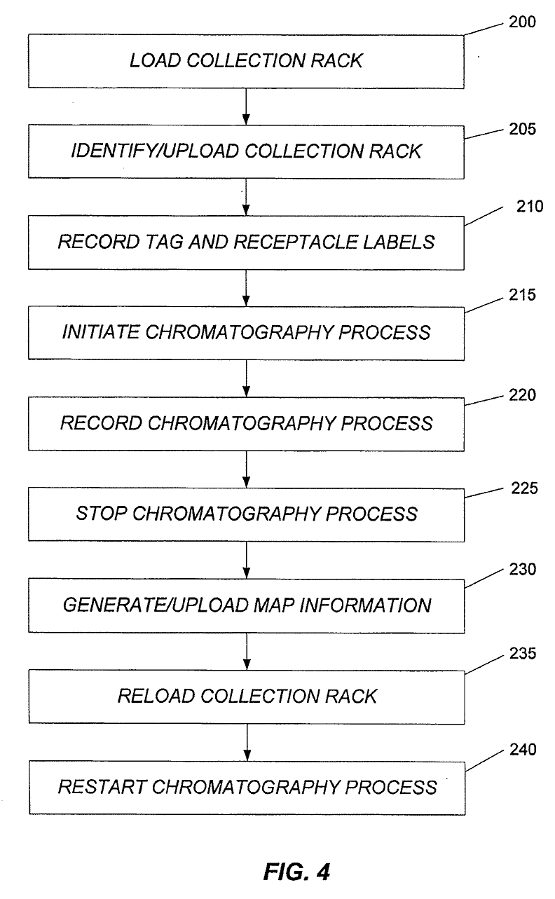

FIG. 4 illustrates a flow chart of a method of performing a chromatography process according to one embodiment of the present invention. A user loads a collection rack 22, 322 (at 200) supporting a number of receptacles 34 to perform a chromatography process. At least one of the rack readers 90 identifies the collection rack 22, 322 (at 205) by reading or detecting the rack label 95 mounted on the rack 22, 322. Subsequent to detecting the rack 22, 322, the rack reader 90 can communicate with the RFID system 7 and the corresponding rack label 95 to upload the rack data or information. The user manually enters or uploads information related to the tag 87 (identifying the fraction collector 10) and/or aperture labels 100 (identifying the receptacles to be used in the process) to the RFID system 7 through the user interface 75 (at 210). The information can also be uploaded to the RFID system 7 automatically.

Once the chromatography process is initiated (at 215), information related to the chromatography process can be uploaded to the appropriate rack labels 95 or the RFID system 7 (at 220). In some cases, the information related to the chromatography process can be uploaded to the RFID system 7 directly by the rack readers 90 and/or the chromatography system 6. The chromatography system 6 can upload such information to the RFID system 7 either via a cable connection or wirelessly. In some cases, the chromatography process can be stopped prior to completion (at 225). As a result, the RF host reader 70 can generate information (at 230) related to the chromatography process and the receptacles 34 used in the chromatography process. The information can include location of the receptacles 34 with respect to the rack 22 and/or with respect to the fraction collection system 5. The information can also include the quantities and types of fractions collected in the receptacles 34.

Subsequently, the information can be uploaded to a database or the Internet (at step 230) through a computer network, for example. The user can reload the collection rack 22, 322 at a different chromatography system (at 235) and restart the chromatography process (at 240) based on the information stored in the corresponding rack label 95 and/or retrieved from the database or the Internet. It is to be understood that the process described in FIG. 4 is only exemplary and some of the steps mentioned above can be performed in a different order or simultaneously. Moreover, other processes can be performed by the fraction collection system 5 and the RFID system 7 that fall within the scope of the invention.

It is to be understood that the terms “label”, “reader”, and “tag” are used broadly to encompass various devices and systems suitable for data tracking and recording. The label and/or tag can include at least one unique identification. In one example, the rack reader 90 as well as the rack labels 95, the aperture labels 100, and the tags 87 can be implemented by using memory or computer chip technology, such as the iButton® developed by Dallas Semiconductor. More specifically, iButton computer chips and/or memory can be used to identify and track the specific location of receptacles 34 in a collection rack 22, 322 as well as record data related to a specific chromatography process conducted in each receptacle 34. Additionally, the tag 87 can be implemented by using electronic paper display technology developed by E Ink Corporation. The electronic display used as tag 87 can be used to selectively update information regarding the fraction collector 10, the collection racks 22, 322, and the specific chromatography processes related to each collection rack 22, 322.

In another example, the labels 95, 100 and tag 87 can be bar codes or machine readable representations (for example, 2-D Code 39, Interleaved 2 or 5, 3-D DataMatrix, PDF417 symbols) and the rack reader 90 can be a bar code reader. Other examples include the use of magnetic closed coupling for providing a one-way read-only system. In some cases, a string of magnets can be used as labels 95, 100 allowing a reader to identify collection racks 22, 322, apertures 56, and receptacles 34 by reading a binary code defined by the string of magnets. Other similar methods of identification and recording fall within the scope of the invention.

What is claimed is:

1. An apparatus to perform a chromatography process, the apparatus comprising:
a fraction collection system including a rack adapted to support at least one receptacle;
a reader coupled to the fraction collection system and operable to detect a first identification coupled to the rack;
a chromatography system connected to the fraction collection system to supply a fraction to the receptacle; and
a RFID system operable to communicate with the reader, the RFID system operable to generate data identifying a first location of the receptacle with respect to the rack, and a second location of the rack with respect to the fraction collection system.

2. The apparatus of claim 1, wherein the fraction collection system includes a second rack adapted to support at least one receptacle, the reader operable to detect a second identification coupled to the second rack.

3. The apparatus of claim 2, further comprising a second reader mounted on the fraction collection system operable to detect one of the first identification and the second identification.

4. The apparatus of claim 3, wherein the RFID system is operable to identify the position of the second rack with respect to the fraction collection system.

5. The apparatus of claim 3, wherein the reader includes an antenna to communicate with the RFID system and the second reader includes a second antenna to communicate with the RFID system.

7. The apparatus of claim 1, further comprising a second chromatography system operable to communicate with the RFID system to receive the data generated by the RFID system.

8. The apparatus of claim 7, wherein the second chromatography system is operable to continue the chromatography process based on the data.

9. A method of conducting a chromatography process, the method comprising:
partially filling a receptacle with a fraction, the receptacle supported by a rack;
positioning the rack in a fraction collection system;
detecting a label on the rack with a reader coupled to the fraction collection system;
transmitting a signal to a RFID system, the signal including data related to the label; and
generating a set of data with the RFID system, the set of data including at least one characteristic of the chromatography process, a position of the receptacle with respect to the rack, and a position of the rack with respect to the fraction collection system.

10. The method of claim 9, further comprising mounting a second rack supporting at least one receptacle to the fraction collection system, a second label coupled to the second rack; and
detecting the second rack.

11. The method of claim 10, wherein detecting the second rack includes detecting the second rack with a second reader.

12. The method of claim 10, wherein detecting the second rack includes detecting the second rack with the reader.

13. The method of claim 12, wherein generating the set of data with the RFID system includes generating data related to the position of the receptacle supported by the second rack with respect to the second rack, and the position of the second rack with respect to the fraction collection system.

14. The method of claim 9, further comprising
stopping the chromatography process; and
the RFID system uploading the set of data to a network.

15. The method of claim 14, further comprising
mounting the rack to a remote chromatography system;
detecting the rack in the remote chromatography system;
uploading information related to the set of data from the network to the remote chromatography system as a result of detecting the rack; and
the remote chromatography system restarting the chromatography process based on uploading the information related to the set of data.

16. The method of claim 9, further comprising the RFID system uploading the set of data to an accessible network.
